(19) United States
(12) Patent Application Publication
(10) Pub. No.: US 2009/0033601 A1
(43) Pub. Date: Feb. 5, 2009

(54) Organic light emitting display and its driving method

(76) Inventors: Hyo-jin Lee, Suwon-si (KR); Il-han Lee, Suwon-si (KR); Jin-Hyun Choi, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 12/081,689

(22) Filed: Apr. 18, 2008

(30) Foreign Application Priority Data
Aug. 2, 2007 (KR) 10-2007-0077708

(51) Int. Cl. G09G 3/30

(52) U.S. Cl. 345/77

(57) ABSTRACT

An organic light emitting display and its driving method includes: a pixel unit divided into a first display region and a second display region; a light emitting control driver outputting in parallel a plurality of light emitting control signals through a plurality of light emitting control lines; a switch unit including a plurality of switches each respectively coupled to one of the plurality of light emitting control lines to switch the transfers of the light emitting control signals to each have a turn-on period and a turn-off period within a period of one frame; and a luminance controller controlling the switching time of the switch unit using image signals and setting the number of switchings of the plurality of light emitting control lines coupled to the first display region differently from that of the plurality of light emitting control lines coupled to the second display region.

### CLAIM OF PRIORITY

This application makes reference to, incorporates the same herein, and claims all benefits accruing under 35 U.S.C. §119 from an application for ORGANIC LIGHT EMITTING DISPLAY AND DRIVING METHOD, earlier filed in the Korean Intellectual Property Office on 2 Aug. 2007 and there duly assigned Serial No. 10-2007-0077708.

### BACKGROUND OF THE INVENTION

1. Field of the Invention

The present invention relates to an organic light emitting display and its driving method, and more particularly, the present invention relates to an organic light emitting display and its driving method which prevent a lowering of image quality due to Organic Light Emitting Diode (OLED) pixel deterioration.

2. Description of the Related Art

A flat panel display includes a plurality of pixels arranged in a matrix on a substrate and further includes scan lines and data lines coupled to the pixels. The pixels display an image corresponding to data signals by selectively receiving the data signals by scan signals.

The flat panel display is used as displays for computers, a cellular phones, and Personal Digital Assistants (PDAs), etc., or monitors for various information equipment. The flat panel displays include Liquid Crystal Displays (LCDs) using liquid crystal panels, organic light emitting displays using OLEDs, and Plasma Display Panels (PDPs) using plasma panels, etc. Among others, the organic light emitting display, which is excellent in view of luminous efficiency, brightness, and viewing angle and has a rapid response speed, has been spotlighted.

The organic light emitting display includes an OLED emitting light corresponding to its current flow. The OLED is a self-emission element so that the OLED is deteriorated if it is emitting light for a long time. Therefore, the luminous efficiency is decreased so that if a constant current is supplied to the organic light emitting display, the gray scale corresponding thereto cannot be displayed. In particular, when the same image is displayed for a long time, the deterioration of such an OLED becomes worse and consequently causes a reduced lifetime and a lowering of its image quality.

### SUMMARY OF THE INVENTION

Therefore, the present invention proposes to solve the above problem. It is an object of the present invention to provide an organic light emitting display and its driving method which prevent a lowering of the efficiency of its OLEDs.

In order to accomplish the above object, according to a first aspect of the present invention, an organic light emitting display is provided including: a pixel unit divided into a first display region and a second display region; a light emitting control driver outputting in parallel a plurality of light emitting control signals through a plurality of light emitting control lines; a switch unit including a plurality of switches each respectively coupled to one of the plurality of light emitting control lines to switch the transfers of the light emitting control signals to each have a turn-on period and a turn-off period within a period of one frame; and a luminance controller controlling the switching time of the switch unit using image signals and setting the number of switchings of the plurality of, light emitting control lines coupled to the first display region differently from that of the plurality of light emitting control lines coupled to the second display region.

In order to accomplish the above object, according to a second aspect of the present invention, a driving method of an organic light emitting display is provided including: forming frame data by summing up a plurality of image signals input to one frame; determining a pulse width of each of the plurality of light emitting control signals corresponding to the frame data, the plurality 11 of light emitting control signals being output in parallel; dividing a pixel unit into at least a first display region and a second display region; and setting the number of switchings of the plurality of light emitting control signals transferred into the first display region differently from that of the plurality of light emitting control signals transferred into the second display region.

With an organic light emitting display and its driving method according to the present invention, a lowering of efficiency and a lowering of image quality due to the deterioration of its OLEDs is prevented.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a front view of a cellular phone adopting an organic light emitting display;

FIG. 2 is a block diagram of an organic light emitting display according to the present invention;

FIG. 3 is a timing diagram of the light emitting control signal output through the switch unit of FIG. 2;

FIG. 4 is a block diagram of a luminance controller adopted to the organic light emitting display of FIG. 2; and

FIG. 5 is a circuit diagram of one example of a pixel adopted to the organic light emitting display of FIG. 2.

### DETAILED DESCRIPTION OF THE INVENTION

Hereinafter, certain exemplary embodiments according to the present invention are described with reference to the accompanying drawings. When a first element is described as being coupled to a second element, the first element may be not only directly coupled to the second element but may also be indirectly coupled to the second element via a third element. Furthermore, elements that are not essential to the complete understanding of the present invention have been omitted for clarity. Also, like reference numerals refer to like elements throughout.

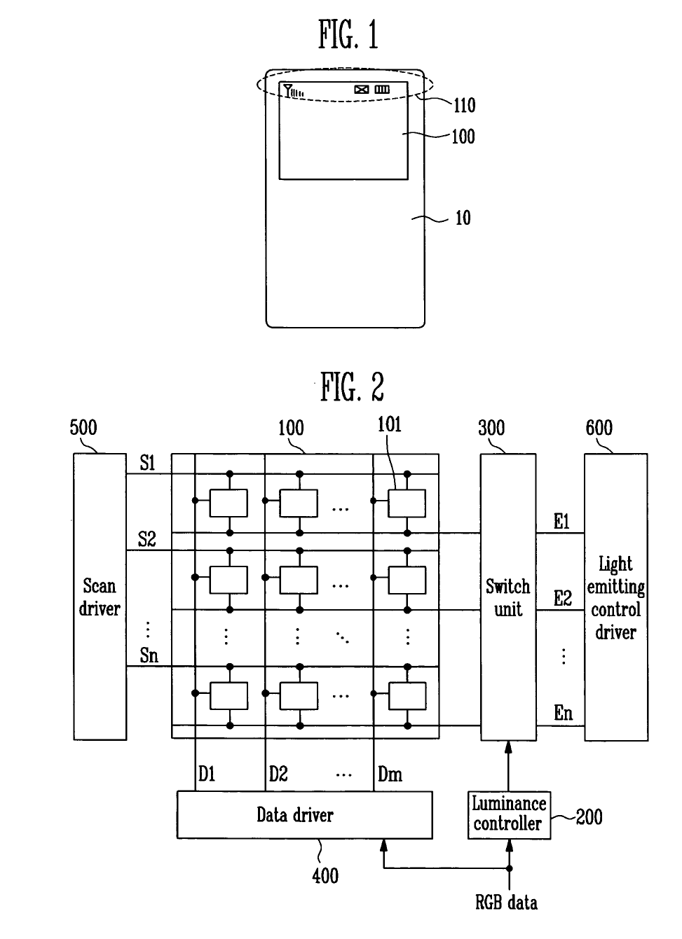

FIG. 1 is a front view of a cellular phone adopting an organic light emitting display. Referring to FIG. 1, the organic light emitting display adopted to a cellular phone 10 according to the present invention includes a pixel unit 100 displaying an image, wherein the pixel unit 100 is divided into a first display region 110 displaying an fixed image, such as icons, etc., and a second display region displaying a moving image, a photograph and a user interface, etc.

The first display region 110 displays a fixed image, such as an icon. If the organic light emitting display is provided in a cellular phone, etc., icons may be used as images displaying a cellular phone receiving display, a Short Message Service (SMS) message arriving and notifying display, a battery capacity display, etc. Therefore, the same current flows into the pixels displaying icons in the first display region 110 since the pixels display the same images for a long time. Accordingly, the deterioration of OLEDs in the first display region 110 rapidly progresses so that 11 the luminous efficiency thereof is decreased faster than that of the OLEDs in the second display region.

The moving image, the photograph, and the user interface, etc., displayed in the second display region have the displayed images changed so that the amount of current flowing into the OLEDs changes. Therefore, the OLEDs of the pixels in the second display region have a better luminous efficiency than the OLEDs of the pixels displaying icons in the first display region 110.

According to the present invention, in order to prevent the luminous efficiency of the OLEDs in the first display region 110 from decreasing, the OLEDs in the first display region 110 are repeatedly turned on and off during the time of one frame. Accordingly, the flow of the same current into the OLEDs in the first display region 110 for a long time can be prevented. Therefore, the lifetime of the OLEDs in the first display region 110 is extended, making it possible to prevent a lowering of efficiency.

FIG. 2 is a block diagram of an organic light emitting display according to the present invention. Referring to FIG. 2, the organic light emitting display includes a pixel unit 100, a luminance controller 200, a switch unit 300, a data driver 400, a scan driver 500, and a light emitting control driver 600.

The pixel unit 100 includes a plurality of pixels 101, a plurality of scan lines S1, S2, . . . , Sn, a plurality of light emitting control lines E1, E2 . . . , En, and a plurality of data lines D1, D2, . . . , Dm. The pixel 101 includes a pixel circuit and an OLED, wherein the pixel circuit, coupled to the scan lines S1, S2, . . . , Sn, the light emitting control lines E1, E2, . . . , En, the data lines D1, D2, . . . , Dm, receives scan signals, light emitting control signals, and data signals to generate a driving current, thereby transferring the generated driving current to the OLEDs. The OLED includes an anode electrode, a light emitting layer, and a cathode electrode. If current flows in a direction from the anode electrode to the cathode electrode of the OLED, the light emitting layer is emits light corresponding to the gray scale value corresponding to the current. Also, the pixel unit 100 is divided into the first display region and the second display region, as shown in FIG. 1.

The luminance controller 200 sets the limit of the brightness of the entire frame to prevent the brightness of the entire frame from exceeding the limit of the brightness. The brightness of the entire frame is determined using frame data summing up the gray scale values of the image signals input to one frame of the brightness. The pulse widths of the light emitting control signals are controlled corresponding to the image signals input to one frame.

The switch unit 300 controls the pulse widths of the light emitting control signals by switching the light emitting control signals. The switch unit 300 includes a plurality of switches each coupled to the light emitting control lines E1, E2, . . . , En, wherein each of the switches determines the pulse widths of the light emitting control signals by corresponding to the switching time of each switch. The pixel unit 100 is divided into a first display region and a second display region, wherein the light emitting control signals transferred to the first display region and the light emitting control signals transferred to the second display region have a difference in view of the number of turned-off portions in one frame period by means of switches coupled to the respective light emitting control signals. The light emitting control signals transferred to the first display region are more often turned-off than the light emitting control signals transferred to the second display region in one frame period.

The data driver 400 is coupled to the plurality of data lines D1, D2, . . . , Dm to transfer data signals to the pixel unit 100. The data signals are generated by receiving image signals and transferring them to the pixel unit 100.

The scan driver 500 is coupled to the plurality of scan lines S1, S2, . . . , Sn to transfer scan signals to the pixel unit 100, thereby allowing data signals to be transferred to the pixel unit 100 selected by the scan signals.

The light emitting control driver 600 is coupled to the plurality of light emitting control lines E1, E2, . . . , En to transfer the plurality of light emitting control signals to the pixel unit 100. In other words, the plurality of light emitting control signals are simultaneously transferred to each pixel 101 through the plurality of light emitting control signals E1, E2, . . . , En. The light emitting control signals are coupled to the switch unit 300 to control switching time by means of the switch unit 300.

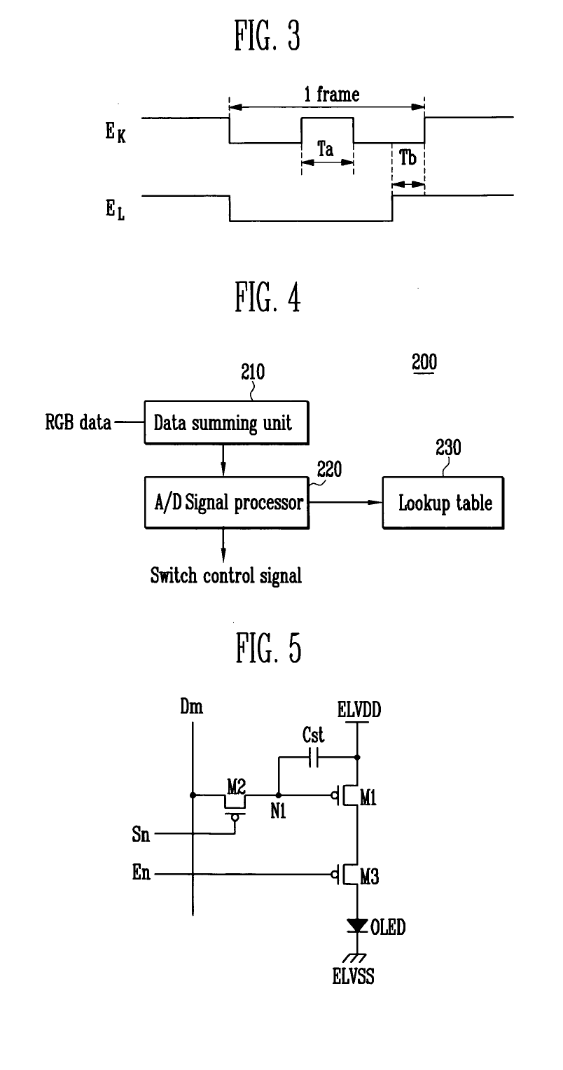

FIG. 3 is a timing diagram of the light emitting control signal output through the switch unit of FIG. 2. Referring to FIG. 3, a first light emitting control signal Eₖ is the light emitting control signal transferred to the first display region, and a second light emitting control signal E_{L} is the light emitting control signal transferred to the second display region.

When the switch provided in the switch unit is turned-off, the first light emitting control signal Eₖ and the second light emitting control signal E_{L} may be set to a high state, and when the switch provided in the switch unit is turned-on, the first light emitting control signal Eₖ and the second light emitting control signal E_{L} may be set to a low state. In other words, the first light emitting control signal Eₖ has two high states in one frame period by means of the switch, and the second light emitting control signal E_{L} has one high state in one frame period by means of the switch. Therefore, although the first display region is once turned-off in one frame period by means of the transferred first light emitting control signal Eₖ to display the same image, there are changes in the current flow so that the lowering of the luminous efficiency of the OLED does not rapidly occur.

Although the first light emitting control signal Eₖ is shown to be switched once more than the second light emitting control signal E_{L}, it is merely an example. It can, however, be switched twice, or three or more times. Also, the second light emitting control signal E_{L} can be switched a plurality of times in one frame period. The time Ta of a high state in one frame period of the first light emitting control signal Eₖ maintains the same time as the time Tb of a high state in one frame period of the second light emitting control signal E_{L}, so that the lowering of brightness due to the switching does not occur.

FIG. 4 is a block diagram of a luminance controller adopted to the organic light emitting display of FIG. 2. Referring to FIG. 4, the luminance controller 200 includes a data summing unit 210, an A/D signal processor 220, and a lookup table 230.

The data summing unit 210 extracts information on the frame data summing up video data having information on red, blue, and green input to one frame. In the frame data, all video data for one frame are summed up. It can be appreciated that if the data values of the frame data are large, data displaying high gray scale are more included in the video data for one frame, and if the data values of the frame data are small, data displaying high gray scale are less included in the video data for one frame. In other words, the luminous area of the pixel unit can be grasped in accordance with the size of frame data. The luminous area is defined by the following equation 1.

Luminous area=(luminance in one frame)/(luminance of pixel unit emitting light at full white) Equation 1

The A/D signal processor 220 outputs the switch control signals corresponding to the pulse widths of the light emitting control signals stored in the lookup table 230 in accordance with the frame data. If the A/D signal processor 220 receives the frame data from the data summing unit 210, it controls the switching operation of the switch according to the pulse widths of the light emitting control signals stored in the lookup table 230. The switch control signals are input to the switch unit 300 to control the switching operation of the switch, thereby controlling the pulse widths of the light emitting control signals transferred to the light emitting control driver 600. The A/D signal processor 220 determines to which display region between the first display region 110 and the second display region the light emitting control signals are transferred, thereby controlling the number of switchings through the switch control signals.

The lookup table 230 stores widths of the light emitting periods of the light emitting control signals in accordance with the data values of the frame data. For example, the values of the frame data are divided from 0 to 63 so that the width of the light emitting period is designated on a one-to-one basis from 0 to 63.

FIG. 5 is a circuit diagram of one example of a pixel adopted to the organic light emitting display of FIG. 2. Referring to FIG. 5, the pixel 101 includes a first transistor M1, a second transistor M2, a third transistor M3, a capacitor Cst, and an OLED.

The source of the first transistor M1 is coupled to a first power supply ELVDD, the drain thereof is coupled to the OLED through the transistor M3, and the gate thereof is coupled to a first node N1, thereby allowing the driving current to flow in a direction from the source to the drain by corresponding to the voltage of the first node N1.

The source of the second transistor M2 is coupled to a data line Dm, the drain thereof is coupled to the first node N1, and the gate thereof is coupled to a scan line Sn, thereby transferring the data signals flowing into the data line Dm to the first node N1 by corresponding to the transferred scan signals through the scan line Sn.

The first electrode of the capacitor Cst is coupled to the first power supply ELVDD, and the second electrode thereof is coupled to the first node N1, thereby maintaining the voltage of the first node N1.

The gate of the third transistor is controlled by the light emitting control line En.

The OLED includes an anode electrode, a cathode electrode, and a light emitting layer positioned between the anode electrode and the cathode electrode, wherein the anode electrode is coupled to the drain of the first transistor M1, and the cathode electrode is coupled to the second power supply ELVSS having lower voltage than the first power supply ELVDD. If the current flows in a direction from the anode electrode to the cathode electrode, the brightness is changed depending on the amount of the flowing current, making it possible to display gray scale.

Although exemplary embodiments of the present invention have been shown and described, it would be appreciated by those skilled in the art that changes might be made in these embodiments without departing from the principles and spirit of the invention, the scope of which is defined in the following claims.

What is claimed is:

1. An organic light emitting display comprising:
a pixel unit divided into a first display region and a second display region;
a light emitting control driver outputting in parallel a plurality of light emitting control signals through a plurality of light emitting control lines;
a switch unit including a plurality of switches each respectively coupled to one of the plurality of light emitting control lines to switch the transfers of the light emitting control signals to each have a turn-on period and a turn-off period within a period of one frame; and
a luminance controller controlling the switching time of the switch unit using image signals and setting the number of switchings of the plurality of light emitting control lines coupled to the first display region differently from that of the plurality of light emitting control lines coupled to the second display region.

2. The organic light emitting display as claimed in claim 1, wherein an icon is displayed in the first display region.

3. The organic light emitting display as claimed in claim 1, wherein the luminance controller comprises:
a data summing unit generating frame data by summing up image signals input to one frame;
a lookup table storing information on the turn-on period and the turn-off period of each of the plurality of light emitting control signals corresponding to frame data; and
a signal processor controlling the switch unit corresponding to the turn-on period and the turn-off period of each of the plurality of light emitting control signals and the first display region and the second display region.

4. A method of driving an organic light emitting display comprising:
forming frame data by summing up a plurality of image signals input to one frame;
determining a pulse width of each of the plurality of light emitting control signals corresponding to the frame data, the plurality of light emitting control signals being output in parallel;
dividing a pixel unit into at least a first display region and a second display region; and
setting the number of switchings of the plurality of light emitting control signals transferred into the first display region differently from that of the plurality of light emitting control signals transferred into the second display region.

5. The method of driving the organic light emitting display as claimed in claim 4, further comprising transferring the plurality of light emitting control signals to the pixel unit through a switch.

6. The method of driving the organic light emitting display as claimed in claim 4, further comprising displaying an icon in the first display region.
